(19) United States
(12) Patent Application Publication
(10) Pub. No.: US 2004/0132616 A1
(43) Pub. Date: Jul. 8, 2004

(54) Thermosensitive recording material and use thereof

(76) Inventors: Bernd Gerecht, Osnabruck (DE); Matthias Marx, Nortorf (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/468,634

(22) PCT Filed: Feb. 20, 2002
(86) PCT No.: PCT/EP02/01756

(30) Foreign Application Priority Data
Feb. 23, 2001 (DE) 101 08 982.1

(51) Int. Cl. B41M 5/20

(52) U.S. Cl. 503/201

(57) ABSTRACT

The invention relates to a thermosensitive recording material, comprising a substrate (1), a thermosensitive recording layer (4) containing a colour former and colour acceptors, a protective layer (5) configured on the recording layer, whereby a coating (6) that covers the surface and is locally delimited is printed onto the protective layer. The invention also relates to the use of the inventive recording material as a ticket.

The invention relates to a thermosensitive recording material comprising a substrate, a thermosensitive recording layer containing color formers and color acceptors and a protective layer formed on the recording layer, and use thereof as a ticket.

A thermosensitive recording sheet of said type is disclosed in EP-B-0 909 242. The protective layer of the recording sheet which is to be used as a label, cash register receipt or ticket and can be readily printed on by the wet offset process comprises in particular bentonite as a pigment with a pigment content of from 20 to 40% by weight, while the binder content comprises relatively large proportions of water-insoluble binder in the form of a polymer dispersion and relatively small proportions of an aqueous solution of a polymer. This publication discloses natural calcium carbonate, precipitated calcium carbonate, silica, alumina and titanium oxide as further pigments in the protective layer. While polyvinyl alcohol is preferably mentioned as the water-soluble binder, the water-insoluble binders are preferably self-crosslinking copolymers of acrylonitrile, methacrylamide and acrylic esters.

EP-A-0 344 705 discloses a protective layer in which from 0.5 to 3 parts by weight of pigment are present per part by weight of binder. Inter alia, polyvinyl alcohol, carboxymethylcellulose, starch and starch derivatives and copolymer emulsions of styrene/butadiene, vinyl acetate/ethylene, vinyl acetate/vinyl chloride/ethylene and methacrylate/butadiene are disclosed as suitable binders for the protective layer. Precipitated calcium carbonate, milled calcium carbonate, talc, kaolin, anhydrous silica, magnesium carbonate, zinc oxide, alumina and aluminum hydroxide are mentioned as suitable pigments in addition to organic pigments. Pigment-containing protective layers which contain only water-soluble binder are described by way of example.

EP-B-0 373 903 relates to a thermosensitive recording paper having an internal adhesive strength of 2.5 kg·cm or more, which has a protective layer having a smoothness of at least 500 Bekk seconds, preferably of from 700 to 1 500 Bekk seconds, which is applied to an intermediate layer containing fine particles of a styrene/acrylate polymer and a binder. Both the water-soluble and water-insoluble high polymers having adequate film formation capability are designated as binders suitable for the protective layer. An optional pigment addition to the protective layer is likewise disclosed, but the publication provides no information about the type of suitable pigments.

Without a doubt the known thermosensitive recording materials have proven useful in numerous applications, for example as office papers and also as tickets, but constantly new requirement profiles which are often contradictory necessitate completely novel innovative products which break with the known approaches to a solution.

With the already known use of thermosensitive recording materials as a ticket and in particular as a travel coupon, there was a growing need for those materials which have on the one hand high resistance to the environment. This is to be understood as meaning the outstanding resistance of the thermosensitive recording material to water, plasticizers, oils and fats. The requirement for resistance to water arises from the fact that characters produced on a travel coupon by the supply of heat must remain decipherable and checkable for the duration of an interval of use even when the travel coupon cannot be protected during storage on rainy days. In the same way, the travel coupon is not permitted to lose its characters on contact with fats and oils. Since travel coupons are frequently stored in document pockets in order to protect them from mechanical destruction, it is furthermore necessary for the thermosensitive recording materials used in this manner to have high resistance to plasticizers such as those usually contained in document pockets.

On the other hand, there is a requirement for higher smudge resistance compared with the prior art and hence more reliable cancelability which, in the context of the object of this invention, is to be understood as meaning that stamped-on cancellation marks cannot be wiped away after about 10 seconds either in the dry state or in the wet state. Up to now, the only known thermosensitive recording materials are those in which the cancellation stamp ink applied to the protective layer cannot be wiped away completely from the protective layer either in the dry state or in the wet state, but the smudge resistance is still not completely satisfactory in that wiping leads to a recognizably more blurred printed image in comparison with the same printed image prior to wiping.

Since tickets and in particular travel coupons usually have imprints applied by means of flexographic printing processes or in particular by means of wet offset printing processes, printability over the entire surface of the protective layer in the areas where the cancellation imprint is not intended is a further requirement.

The necessity for recording materials suitable for use as travel coupons to be capable of being produced economically should not be underestimated. None of the known thermosensitive recording materials has been able to date completely to fulfill this spectrum of requirements.

In summary, it is an object of the present invention to provide a thermosensitive recording material which, as a ticket and in this case especially as a travel coupon, guarantees outstanding localized cancelability through greater smudge resistance of imprints with cancellation stamp ink. The novel recording material must be distinguished by high resistance to the environment. Furthermore, an important aspect of the novel recording material is that it must be economical to produce. Moreover, an object of the invention is to develop a recording material which, in addition to the abovementioned spectrum of requirements, also has outstanding printability over the entire surface of the protective layer in those areas in which a cancellation imprint is not intended.

As a result of extensive preliminary work, the inventors recognized that such a multiplicity of requirements, some of which are contradictory, can be met by a thermosensitive recording material comprising a substrate, a thermosensitive recording layer containing color formers and color acceptors and a protective layer formed on the recording layer, a solid, localized coating being imprinted on the protective layer.

For economic reasons, a particularly suitable embodiment of the present invention provides the protective layer in the form of a single layer.

The thermal printing head triggering the color-forming reaction of the color formers with the color acceptors in the thermosensitive recording layer causes melting of the waxy components in the recording layer. In order to avoid adhesion of these waxy components as a melt to the thermal printing head, it is preferable to form an intermediate layer containing a pigment or a pigment mixture between thermosensitive recording layer and substrate, the pigments of this intermediate layer effecting absorption of the melt. It is particularly advantageous if the pigments of the intermediate layer have an oil absorption of at least 80 cm³/100 g and even better of 100 cm³/100 g, determined according to Japanese standard JIS K 5101. Owing to its large absorption reservoir in the cavities, calcined kaolin has proven particularly useful. In numerous experiments, it has been found that it is advantageous to choose, in the intermediate layer, pigments having higher oil absorption than in the “spot” coating, i.e. the solid and localized coating printed on the protective layer. Since the air in the cavities of the pigments of the intermediate layer is a good heat insulator, an intermediate layer formed in this manner acts as a heat reflection layer, with the result that the thermosensitivity of the recording material and hence the printing speed in the thermal printer can be increased. Furthermore, such an intermediate layer can make a positive contribution to the leveling of the substrate surface, with the result that the amount of coating slip which has to be applied for the thermosensitive recording layer is reduced. The formation of an intermediate layer having a mass per unit area in the range of from 5 to 20 g/m² and even better between 7 and 10 g/m² is particularly advantageous.

A coating slip as proposed in EP-B-0 909 242 is suitable for the formation of the protective layer for the novel recording material. Such a protective layer combines high resistance to the environment with outstanding printability by the wet offset process. Furthermore, the protective layer can be relatively economically produced and applied as a single layer.

In order to support the cancelability of the novel recording material in localized areas and to ensure that only as thin a print coat of the “spot” coating as possible need be applied, which is appropriate for increased resolution of the heat-induced protective images, it has proven particularly advantageous if

the pigment of the protective layer consists of one or more inorganic pigments and at least 80% by weight are formed from a highly purified bentonite prepared under alkaline conditions,

the binder of the protective layer consists of one or more water-insoluble, self-crosslinking acrylic polymers,

the binder/pigment ratio in the protective layer is in the range between 7:1 and 9:1,

the crosslinking agent/binder ratio in the protective layer is greater than 1:5 and preferably between 1:5 and 1:7 and

the protective layer has a smoothness of at least 900 Bekk seconds.

Natural or precipitated calcium carbonate, kaolin or titanium oxide are possible as further inorganic pigments for the protective layer.

In particular, cyclic urea, methylolurea, polyamide-epichlorohydrin resin and ammonium zirconium carbonate are possible crosslinking agents for the protective layer. An embodiment described above ensures a thermosensitive recording material which has good printing head behavior over the entire area and whose protective layer simultaneously has good resistance to the environment, in accordance with the object, and outstanding printability by the flexographic and wet offset process.

It is preferable to apply the protective layer in a mass per unit area in a range of from 1.5 to 6 g/m², in particular between 1.8 and 4 g/m².

The recording material according to the invention preferably has a backing coating which is applied on the substrate side which is opposite the side provided with the thermosensitive recording layer. Such a backing coating is proposed, for example, in DE-A-197 48 258 and then serves for improved printability of the back of the recording sheet by the offset and flexographic process and an improved barrier effect at the back with respect to plasticizers, oils and fats. Applied amounts in a range of from 1 to 3 g/m² and in particular between 1.5 and 2.5 g/m² have proven advantageous for the mass per unit area of the backing coating.

The solid, localized so-called “spot” coating is preferably printed on in the form of a rectangle at the edge of the thermosensitive recording material finished as a travel coupon, i.e. printed and cut. The printing ink used for this purpose preferably contains pigments having an oil absorption of at least 80 cm³/100 g, determined according to Japanese standard JIS K 5101. As already explained above, it is advantageous to choose the oil absorption of the pigments in the intermediate layer to be greater than the oil absorption of the pigments in the “spot” coating. An embodiment which is furthermore preferred envisages that from 60 to 90% by weight of the printing ink applied as a “spot” coating comprises a pigment having an oil absorption of at least 80 cm³/100 g. Further components of the water-based printing inks for the “spot” coating are alcohols, such as isopropanol or ethanol, as solvents and, for example, maleate, polyester and acrylate resins as binder, whose carboxyl groups have been hydrolyzed with aqueous ammonia or with amines and converted into water-soluble salts. The printing inks thus prepared are outstanding when used for stamping and the applied stamp ink is smudge-resistant after about 10 seconds.

Although not limited to paper as a substrate, paper is the substrate which has become established on the market, including in view of its good environmental compatibility owing to its good recyclability, and which is preferred in the context of the invention.

The thermosensitive recording material according to the invention is mainly conceived for use as a ticket and in this case in particular as a travel coupon. After purchase and before starting the journey, the travel coupon is inserted by the passenger into a automatic cancellation apparatus provided for this purpose so that the cancellation imprint is applied to the solid, localized so-called “spot” coating. After about 10 seconds, the cancellation imprint has dried to a smudge-resistant state so that there is no danger of the passenger becoming soiled from the insufficiently fixed printing ink. At the same time, the imprint can also be readily deciphered without problems for checking purposes. Extensive investigations have shown that a printing ink coat having a mass per unit area in a range of from 1 to 5 g/m² and in particular between 2 and 3.5 g/m² gives particularly good results.

Since the intended use of the thermosensitive recording material according to the invention as a travel coupon sometimes also requires authenticity features, the incorporation thereof is also envisaged in a preferred embodiment. An overview of possible authenticity features to be used individually or in combination is given in DE-A-199 36 030, but without the latter being restricted to the proposals made therein.

The data provided in the description and in the claims on mass per unit area, in % by weight, are based in each case on the absolutely dry weight, i.e. absolutely dry parts by weight.

The high resistance to the environment of the recording material according to the invention is to be understood as meaning its outstanding resistance to the media

water,

plasticizers and

oils and fats.

The method used for establishing the resistance to the environment envisages that a measuring cycle comprising 3 independent determinations of individual values is carried out per resistance test.

A determination of an individual value envisages that first a DIN A4 sample is cut. For the determination of the individual value, the ratio of two measurements of the dynamic print density, determined with the aid of the Macbeth RD 914 from Karl Schröder KG (Korrillonstrasse 32, D-69469 Weinheim), is measured. For this, the sample is provided with characters using a thermal printer of the type TP 3000-300 from Charles Richiger AG, Maschinenbau (Bernstrasse 81, CH-3613 Steffisburg). After a first measurement of the dynamic print density, the sample is directly exposed to the corresponding medium for a certain time (for contact time, cf. table). The excess medium is then sucked off or dabbed off. Medium already absorbed by the sample is allowed to act for a certain time (for standing time before measurement, cf. table). Finally, the dynamic print density is measured a second time.

The arithmetic mean of the 3 individual values thus determined is calculated. The investigated resistance to the medium is designated as being very good if the arithmetic mean of the quotients determined from two measured values in each case is greater, as individual values, than the “limit of character stability” according to table 1.

TABLE 1

| Medium | Water | Hand cream | Milk (3.5% fat | Tesa-Grafik film |
|---|---|---|---|---|
| | | Pfeilring | content) | 57410 (Beiersdorf, |
| | | Lanolin Creme- | | D-21147 Hamburg) |
| | | Soft (Viva GmbH, | | |
| | | D-50858 Cologne) | | |
| | | Fats and oils | | Plasticizers |
| Application | 1 drop | Dense coat | 1 drop | Different sequence |
| Contact time | 30 minutes, then | 10 minutes, then | 30 minutes, then | here: produce |
| | suck off | dab off | suck off | characters as |
| | | | | described; then |
| | | | | stick on Tesa film |
| | | | | and then measure |
| | | | | dynamic print |
| | | | | density |
| Standing time | 3 hours under | 3 hours under | 3 hours under | 3 hours under room |
| before | room conditions | room conditions | room conditions | conditions |
| measurement | | | | |
| Limit of | >90% | >95% | >90% | >85% |
| character | | | | |
| stability | | | | |

The examples further illustrate the invention:

### EXAMPLE 1

A paper web is produced on a Foudrinier paper machine as a substrate from bleached and beaten hardwood and softwood pulps having a mass per unit area of 67 g/m² with addition of conventional additives in conventional amounts. An 8 g/m² intermediate layer comprising calcined kaolin as pigment, styrene/butadiene latex as binder and starch as cobinder in addition to further assistants is applied to the front.

A thermosensitive recording layer containing color formers and color acceptors and having a mass per unit area of 5.4 g/m² is applied to the intermediate layer.

A protective layer of 2 g/m² is applied to the dried recording layer. A highly purified bentonite which has been prepared under alkaline conditions and has a lamellar structure and whose intrinsic adhesion permits fixing with a low binder requirement and whose specific surface area in the undispersed state is specified as 85 m²/g is used as a pigment with an area/edge ratio which, in the case of the bentonite present in, powder form, varies within a range between 20 and 50. A binder/pigment ratio of 6:1 and a crosslinking agent/binder ratio of 1:5 are established. The crosslinking agent used is a polyamide-epichlorohydrin resin and the binder used is the aqueous dispersion of a self-crosslinking copolymer of acrylonitrile, methacrylamide and acrylic esters. The coating slip for the production of the protective layer contains, as further components, an antifoam, stearic acid as a lubricant and various dispersants, on the one hand for the pigment and on the other hand for the lubricant.

The applied coating slip is dried and the recording sheet produced to this stage is smoothed by means of a calander, a smoothness of 2 200 Bekk seconds being achieved.

In each case 8 mm wide strips are then printed as “spot” coatings in a mass per unit area of 2.2 g/m² on the protective layer in such a way that the “spot” coating strips in the finally cut travel coupon are arranged at two opposite outer lines of the travel coupon. The printing ink “DG 9033 (matt coat)” supplied by GSB-Wahl GmbH, Buchenteich 1, D-73773 Aichwald, is used.

That side of the thermosensitive recording material according to the invention produced in this manner which is provided with a protective layer is checked with regard to its resistance to the environment in the areas not printed with a “spot” coating and is determined to be very good. The cancellation imprint is checked after 10 seconds with a moistened finger with regard to its smudge resistance; the cancellation imprint cannot be smudged.

### EXAMPLE 2

In each case 10 mm×50 mm “spot” coating rectangles are printed in a mass per unit area of 3.2 g/m² on the protective layer of a thermosensitive recording material produced according to example 1 of EP-B-0 909 242, in such a way that the “spot” coating rectangles in the finally cut travel coupon are arranged with their long side parallel to an outer line of the travel coupon. The printing ink “DG 9033 (matt coat)” supplied by GSB-Wahl GmbH, Buchenteich 1, D-73773 Aichwald, is used.

That side of the thermosensitive recording material according to the invention produced in this manner which is provided with a protective layer is checked with regard to its resistance to the environment in the areas not printed with a “spot” coating and is determined to be very good. The cancellation imprint is checked after 10 seconds with a moistened finger with regard to its smudge resistance; the cancellation imprint cannot be smudged.

### EXAMPLE 3

In each case 10 mm×50 mm “spot” coating rectangles are printed in a mass per unit area of 2.8 g/m² on the protective layer of a thermosensitive recording material produced according to example 2 of EP-B-0 909 242, in such a way that the “spot” coating rectangles in the finally cut travel coupon are arranged with their long side parallel to an outer line of the travel coupon. The printing ink “DG 9032” supplied by GSB-Wahl GmbH, Buchenteich 1, D-73773 Aichwald, is used.

That side of the thermosensitive recording material according to the invention produced in this manner which is provided with a protective layer is checked with regard to its resistance to the environment in the areas not printed with a “spot” coating and is determined to be very good. The cancellation imprint is checked after 10 seconds with a moistened finger with regard to its smudge resistance; the cancellation imprint cannot be smudged.

### EXAMPLE 4

In each case 10 mm×50 mm “spot” coating rectangles are printed in a mass per unit area of 3.3 g/m² on the protective layer of a thermosensitive recording material produced according to example 3 of EP-B-0 909 242, in such a way that the “spot” coating rectangles in the finally cut travel coupon are arranged with their long side parallel to an outer line of the travel coupon. The printing ink HK 9035 supplied by Akzo Nobel, Kreuzauer Strasse 46, D-52301 Düren is used. That side of the thermosensitive recording material according to the invention produced in this manner which is provided with a protective layer is checked with regard to its resistance to the environment in the areas not printed with a “spot” coating and is determined to be very good. The cancellation imprint is checked after 10 seconds with a moistened finger with regard to its smudge resistance; the cancellation imprint cannot be smudged.

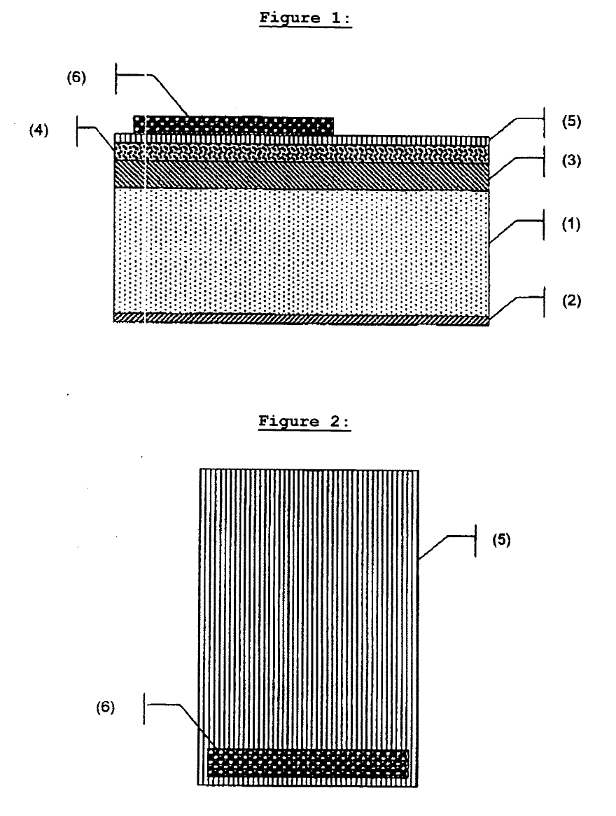

The invention is further explained below with reference to the two FIGS. 1 and 2.

FIG. 1 shows the schematic structure of the thermosensitive recording material according to the invention in cross section. A backing coating (2) is applied to the underside of the substrate (1). In the sequence represented here, an intermediate layer (3), a thermosensitive recording layer (4) and a protective layer (5) are applied to the front of the substrate (1). Finally, a solid, localized print coat (6) is arranged on the protective layer.

FIG. 2 shows, by way of example, a plan view of the thermosensitive recording material according to the invention, cut to form a travel coupon. The solid, localized print coat (6), in the form of a rectangle which is arranged with its long side parallel to an outer line of the travel coupon, is applied to the protective layer (5) exclusively visible in the plan view.

1. A thermosensitive recording material comprising a substrate, a thermosensitive recording layer containing color formers and color acceptors and a protective layer formed on the recording layer, characterized in that a solid, localized coating is applied as a “spot” coating to the protective layer.

2. The thermosensitive recording material as claimed in claim 1, characterized in that the applied printing ink contains a polyester- or acrylic resin-based binder.

3. The thermosensitive recording material as claimed in either of claims 1 and 2, characterized in that the protective layer is formed as a single layer.

4. The thermosensitive recording material as claimed in any of claims 1 to 3, characterized in that the protective layer has a smoothness of at least 900 Bekk seconds.

5. The thermosensitive recording material as claimed in any of claims 1 to 4, characterized in that an intermediate layer containing a pigment or a pigment mixture is formed between substrate and thermosensitive recording layer.

6. The thermosensitive recording material as claimed in any of claims 1 to 5, characterized in that the pigments in the intermediate layer have an oil absorption of at least 80 cm³/100 g.

7. The thermosensitive recording material as claimed in any of claims 1 to 6, characterized in that the applied printing ink contains pigments having an oil absorption of at least 80 cm³/100 g.

8. The thermosensitive recording material as claimed in any of claims 1 to 7, characterized in that 60-90% by weight of the applied printing ink comprises pigments having an oil absorption of at least 80 cm³/100 g.

9. The thermosensitive recording material as claimed in any of claims 1 to 8, characterized in that the pigments in the intermediate layer have a higher oil absorption than the pigments in the “spot” coating.

10. The thermosensitive recording material as claimed in any of claims 1 to 9, characterized in that a backing coating is applied to that side of the substrate which is opposite the side with the thermosensitive recording layer.

11. The thermosensitive recording material as claimed in any of claims 1 to 10, characterized in that the substrate is paper.

12. The use of a thermosensitive recording material as claimed in any of claims 1 to 11 as a ticket.

13. The use of a ticket as claimed in claim 12 for the application of at least one cancellation imprint to the solid, localized coating.
